(19) United States
(12) Patent Application Publication
(10) Pub. No.: US 2025/0263643 A1
(43) Pub. Date: Aug. 21, 2025

(54) SPIRIT FINISHING APPARATUS AND METHOD

(71) Applicant: Booze Baggers LLC, Dalals, TX (US)

(72) Inventor: John Kreusch, Dallas, TX (US)

(21) Appl. No.: 19/054,872

(22) Filed: Feb. 16, 2025

Related U.S. Application Data
(60) Provisional application No. 63/554,244, filed on Feb. 16, 2024.

(51) Int. Cl. C12G 3/07; B65D 85/812

(52) U.S. Cl. CPC C12G 3/07; B65D 85/812

(57) ABSTRACT

Described are methods and apparatus for providing a flavoring agent in a permeable material, the flavoring agent in the form of a flavoring apparatus to be used in flavoring a single pour or small volume of an alcoholic beverage. In particular a finishing assembly that can contain a finishing wood retained in a fluid permeable receptacle, the fluid permeable receptacle configured to be placed in a volume of spirit or alcoholic beverage and at least partially submerged in the spirit or the alcoholic beverage.

### RELATED APPLICATIONS

This Application claims priority to U.S. Provisional Patent Application 63/554,244 filed Feb. 16, 2024, which is incorporated herein by reference in its entirety.

### FIELD OF THE INVENTION

Embodiments generally related to the field of spirits and alcoholic beverages, in particular to the field of flavoring or finishing of a spirit or alcoholic beverage.

### BACKGROUND

Alcoholic beverages including spirits like whiskey typically employ conventional production processes. For instance, a “malting” process is typically the first step employed where a grain (e.g., barley) may be moistened with water allowing it to germinate. This malting process allow enzymes to be released converting unfermentable starch into fermentable sugars. Next, a “mashing” process is employed to extract the fermentable sugars by agitating the ground grains in a mash tun with hot water. The mashing process is intended to produce a mixture (i.e., “mash” or “wort”) that is comprised of simple sugars. A “fermentation” process may then introduce the mash/wort with a yeast where the simple sugars can be converted to alcohol. A “distillation” process may then use a still (e.g., a pot or column still) to separate/evaporate the alcohol from water and other substances. The evaporated alcohol may then be cooled using a condenser unit thereby providing an “unaged” or “distillate” spirit (e.g., whiskey).

Generally, the distillation process may not require an extended period to complete (e.g., typically a few days). While the unaged spirits (e.g., rum, tequila, whiskeys, sherry, cognac, brandy, etc.) are considered consumable or drinkable, it is generally clear in color and may not have the same taste or color that many associate with a fully aged whiskey. Therefore, unaged whiskey typically undergoes a maturation process where a producer attempts to improve the unaged whiskey's taste, color, and smoothness. Traditionally, the maturation process involves placing the unaged whiskey into wooden barrels which may be stored in temperature and humidity-controlled facilities (warehouses or rickhouses) for several years. Producers may mature/age a given whiskey from anywhere between one month to twenty years.

While maturation is typically employed by producers of alcoholic beverages, there are known drawbacks to the maturation process. First, maturation involves considerable costs related to purchasing or manufacturing the wood barrels (typically made of oak) that the whiskey is stored in during the aging process. Also, the storage of wood barrels in large, temperature-controlled warehouses used during the aging process adds significant costs to whiskey production. The time necessary to age whiskey (e.g., 3 years, 5 years, 10 years) also require producers to wait before profits from the aged whiskey may be realized. If anything goes wrong during the aging process, a producer may incur substantial loses. Even during a successful maturation process, losses are incurred because spirits such as whiskey naturally evaporates through the wood barrels over the course of being aged. And the longer whiskey is aged, a greater amount of whiskey will evaporate decreasing the amount of fully aged whiskey that is eventually available for sale.

During the aging process, flavor and other finishing characteristics (infusion or solubilization of various molecular moieties that effect taste, smell, and other attributes of a whiskey or other spirit) is imparted to the whiskey through the contact between the beverage and wood, generally oak. Such enhancement may result from the contact with oak barrels or the addition of oak staves to create the flavor that is desired in whiskies. Some distilleries are double or triple finishing, that is they transfer an age spirit from a first barrel into a second fresh barrel to give it more flavor. They use new whiskey barrels, old wine barrels, and other exotic wood types for these “barrel finishing” options.

One example of the use of wood to enhance the flavor of a whiskey is described in U.S. Pat. No. 1,976,091 to Pritchett. Pritchett describes the addition of chips of wood that have been meticulously processed, into a container such as a keg of whiskey, to contact the whiskey and to reduce the amount of time of ageing and flavoring of the whiskey. While useful, there is a difficulty in that the flavoring process of Pritchard is not carried out by the consumer. Another difficulty is the buoyancy and surface area of the wood. As a consequence, the flavoring of the beverage by means of the wood chips is not within the control of the ultimate consumer of the alcoholic beverage; that is, the contact with the wood chips does not take place under the control of the actual consumer who may prefer to determine the amount of time that the flavorant is in contact with the alcoholic beverage in order to achieve a particular, preferred flavor of the alcoholic beverage.

Another development with alcoholic beverages concerns the preparation of flavored spirits. This is particularly popular in the instance of beverages that have a muted or purely alcoholic taste, e.g., vodka and gin (neutral spirits). In such instances, the alcoholic beverages have been prepared with flavorings such as fruit flavors, and other flavors such as vanilla and chocolate, and these have been included prior to bottling. The resulting products are sold as sealed containers, with the entire contents bearing the flavor that has been included.

One example of flavoring a spirit is the preparation of a cocktail base using an infusible beverage composition as described in US Patent Publication 2022/0330578 to Sayso Beverages, Inc. Sayso describes a device and method for infusion of an aqueous cocktail base. Limitations of Sayso include the need for an aqueous base and the presence of a sweetener and a dehydrated food product for making a mixer for a cocktail.

While the consumer may enjoy a pre-aged beverage, there may be the desire to modify the flavor to suit the taste of the individual. In the instance of barrel aged spirits, the consumer may wish to intensify or modify the flavor of the spirit, while in the instance of spirits such as vodka or gin, the consumer may wish to introduce a new flavor to an otherwise unflavored product. In both instances, the consumer may wish to modify the flavor of the particular beverage to suit individual taste.

It would therefore be advantageous to have a finishing composition that could be used on pour by pour basis and tailored to individual preferences.

### SUMMARY

Embodiments described herein provide a solution to the problems of finishing a spirit or an alcoholic beverage discussed above by providing a finishing agent in a permeable material in the form of a fluid permeable receptacle used in finishing a volume of a spirit or an alcoholic beverage. The volume can be but is not limited to a production volume (e.g. cask or barrell volumes of 5, 10, 20, 30, 40, 50, 100 to 200 or more liters or gallons), retail volume or bottle volume (0.25, 0.5, 1, 2, 3, 4, to 5 liters or gallons) or consumption volume or single pour volume (0.5, 1, 2, 3, 4, 5 to 6 ounces which is approximately equivalent to 10, 50, 100, 150 to 200 milliliters).

In one embodiment a finishing agent contained within a permeable material is dipped or submerged into a spirit or an alcoholic beverage, or the spirit or the alcoholic beverage is poured over the permeable material to finish the alcoholic beverage. The character of the finishing agent and the time of exposure to the finishing agent can be varied to provide various customized profiles.

In certain aspects the fluid permeable receptacle can be a tea bag or similar container. The term “tea-bag” refers to a bag or device with pores adapted to retain particulate material in the bag but at the same time allow the spirit or the alcoholic beverage into which the tea bag is immersed to pass freely in and out of the bag and to impart a finish to the spirit or the alcoholic beverage, a finish being the addition of various substances from the finishing agent that are soluble in the alcoholic beverage and small enough to permeate the material, thus finishing or altering the flavor profile of the alcoholic beverage. After the fluid permeable receptacle has been in contact with the spirit or the alcoholic beverage for a user-determined period of time, the fluid permeable receptacle and the retained content may be removed from the spirit or the alcoholic beverage. The size or volume of the fluid permeable receptacle can vary depending on the volume of particles it is designed to contain, for example the fluid permeable receptacle can have a width of 1 to 20 cm, a length of 1 to 20 cm, and an expanded depth (the depth of a bag can vary depending on how full the bag is) of 0.5 to 20 cm. The size limitations of the fluid permeable receptacle are imposed by the container in which volume of spirit is contained and can be a width, length, depth that can be introduced and removed from such a container.

Certain embodiments are directed to methods of finishing a volume (e.g., production volume, retail volume, or consumption volume/single serving) of alcoholic beverage comprising: (i) contacting a volume (e.g., for a consumption or single serving 0.5 to 6 ounces) of a spirit or an alcoholic beverage in a container (e.g., a single pour container) with a finishing wood retained in a fluid permeable receptacle; (ii) soaking the fluid permeable receptacle in the spirit or the alcoholic beverage at a temperature of 0 to 90 degrees Celsius. In certain aspects soaking can be for 1 minute to 2 hours. The method can further include removing the fluid permeable receptacle after a predetermined time, alternatively, the spirit can be drunk with the fluid permeable receptacle in the spirit. The finishing wood can be a roasted finishing wood. The finishing wood can be one or more of oak, maple, birch, cherry, mulberry, apple wood, amburana, alder, hickory, mesquite, pecan, boxelder, or walnut. In certain aspects two or more finishing woods are retained in the same fluid permeable receptacle. Alternatively, two or more fluid permeable receptacles can be introduced with different finishing wood(s) to customize the finish. The fluid permeable receptacle can be a cotton bag, paper bag, or polymer bag. In certain aspects the fluid permeable receptacle is a wire mesh container or a perforated metal container. In certain aspects the single pour container is a whiskey glass, glencairn nosing glass, rocks glass, wine glass, brandy snifter, highball glass or a neat glass. The alcoholic beverage can be a spirit. In certain aspects the spirit is whiskey. In a particular aspect the whiskey is bourbon. In other aspects the beverage can be a non-alcoholic beverage, or a non-distilled alcoholic beverage such as beer and the like.

Certain embodiments are directed to a finishing assembly comprising a finishing wood retained in a fluid permeable receptacle, the fluid permeable receptacle configured to be placed in a volume of spirit or alcoholic beverage and at least partially submerged in a spirit or an alcoholic beverage. The finishing assembly can be a single serve finishing assembly or a finishing assembly configured to finish a production volume or retail volume. The finishing wood can be a roasted finishing wood. The finishing wood can be one or more of oak, maple, birch, cherry, mulberry, apple wood, amburana, alder, hickory, mesquite, pecan, boxelder, or walnut. In certain aspects two or more finishing woods are retained in one or more fluid permeable receptacle. The fluid permeable receptacle can be a cotton bag, a paper bag, or a polymer bag; or alternatively the fluid permeable receptacle is a wire mesh container or a perforated metal container. The container or single pour container can be a whiskey glass, glencairn nosing glass, rocks glass, wine glass, brandy snifter, highball glass or a neat glass. In other aspects the container can be a bottle, carafe, cask, barrel, or the like. In certain aspects the fluid permeable receptacle is attached to a retrieval component. The retrieval component can be a string, chain, or stick.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps) but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim taken as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. Illustration of two examples of embodiments of the invention.

FIG. 2. Illustrations of selected examples of fluid permeable receptacle configurations.

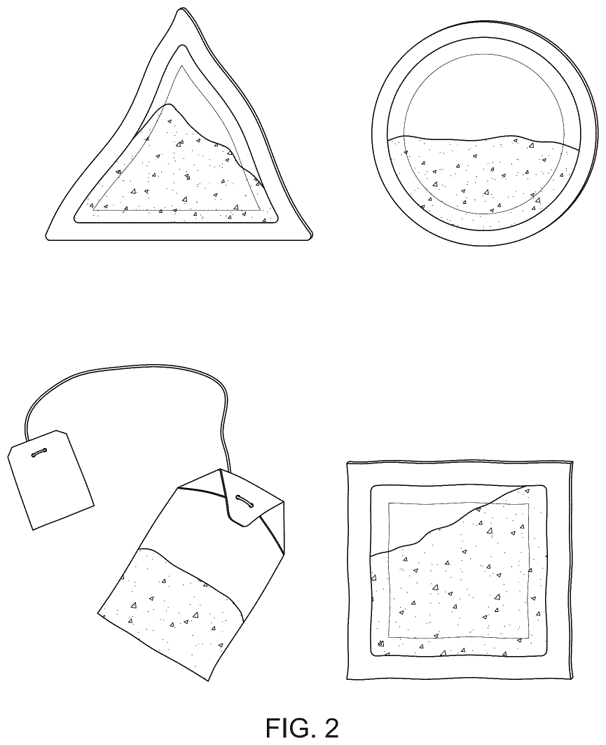

### DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to imply that the scope of the disclosure, including the claims, is limited to that embodiment.

As discussed above, a spirit produced from the distillation process is not the final product many consumers purchase. For instance, an unaged whiskey may be clear in color and may not have the desired texture or taste of aged or “matured” or “finished” whiskey. Certain embodiments of the invention provide articles and methods that allow consumers to tailor a spirit or an alcoholic beverage to their individual preference, employing a post-production maturation or finishing process to improve characteristics of an alcoholic beverage, e.g., the taste, color, and smoothness of a given spirit.

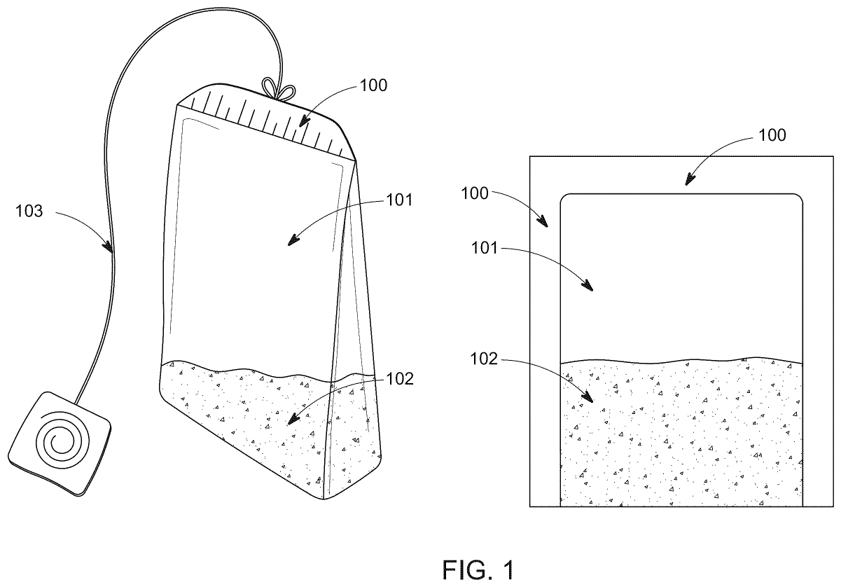

FIG. 1 illustrates two examples of a fluid permeable receptacle in the form of a fluid permeable bag configuration (left) and square configuration (right). The fluid permeable receptacle can be but is not limited to a wire mesh, a perforated metal, a cotton, a paper, or a polymer receptacle. The fluid permeable receptacle can be in a variety of three-dimensional shapes, including but not limited to a pyramid, sphere, cone, cube, rectangular prism, triangular prism, cylinder, tetrahedron, ellipsoid, torus, wedge, etc. In particular, the fluid permeable receptacle can be a pyramidal bag, a round bag, tea bag, square pillow bag, or rectangular pillow bag. The example in FIG. 1 comprises a permeable material in the form of a bag 101 and a finishing agent 102 contained within bag 101. Bag 101 comprises seal(s) 100 to retain the finishing agent in the permeable material. In certain aspects the seal is in the form of a drawstring. Finishing agent 102 can be wood particles produced from one or more woods. In certain aspects the wood particles are roasted. The degree of roast can be controlled by the temperature to which the wood particles are exposed and the exposure time. The temperature for roasting can be from 350 to 500 degrees Fahrenheit; in particular, 425 to 475 degrees Fahrenheit; and more particularly 450 degrees Fahrenheit. The roasting time can vary depending on the desired outcome but is typically 60 to 120 minutes.

Finishing agents. The primary finishing agent is wood, and particularly roasted wood. Various flavoring compositions can be generated by variations in the sourcing and treatment of wood particles contained in a permeable material. The roasted wood may act as a filter, changing or possibly eliminating various congeners in the spirits. It is also contemplated that roasting may allow the spirit to extract natural flavors of the wood. A wood can be oak (e.g., French oak, white oak, Red oak, etc.), maple (e.g., sugar maple), birch (e.g., yellow birch), fruit (e.g., cherry, mulberry, apple), amburana, alder, mesquite, nut (e.g., pecan, walnut, hickory, etc.) or any other similar woods such as boxelder as an example.

While the above discusses the maturation process as it applies to spirits such as distilled whiskey, many of the same issues are common to other alcoholic beverages such as wine, beer, and brandy. A system and method are desirable that can accelerate or provide an impromptu maturation or finishing of alcoholic beverages while still maintaining the taste, coloring, and smoothness of the final aged and matured alcoholic beverage. The maturation or finishing process is used with small volumes at the leisure of the drinker.

In certain aspects of the invention, it is desirable for a spirit to be matured/finished in small volumes, such as single pour of 0.5, 1, 1.5, 2, 2.5, 3, 3.5, 4, 4.5, 5, 5.5, to 6 ounces. A single pour can be in a variety of drinking containers, e.g., a container made of glass, ceramic, plastic, or other appropriate materials. A drinking container can be but is not limited to a whiskey glass, glencairn nosing glass, rocks glass, wine glass, brandy snifter, highball glass or a neat glass.

Methods for flavoring a spirit in small volumes can include one or more of the following steps and/or conditions. Selecting an individual fluid permeable receptacle (e.g., packet or bag) having a finishing agent for a desired flavor profile. The flavor profile is related to the type of wood(s), shape and character of the wood particles, the processing of the wood particles, and the like. Selecting a spirit or alcoholic beverage to be flavored. In certain aspects the wood particles are roasted. It is also contemplated that the roast level can vary to provide variety in the finishing. For instance, the wood may be roasted to a dark roast using a high level of heat/time. The roast level will be determined by the temperature and the roast time. The wood particles can be shreds, pellets, beads, chips, or shavings. A shred is a fine pulverized wood. Wood shreds can be produced using a hammer mill, shredding machine, or mulcher. The particle size can be 0.5 mm to less than 10 mm as measured along the longest axis, in certain aspects the particle size is 2 mm to 5 mm, in particular aspects a particle is 3 mm. In larger volume finishing the fluid permeable receptacle and particle size can be adjusted, the particle size can be increased to 10 mm to 100 mm or more. Particles can sized by sieving. A sieve size refers to the dimensions of the openings in a sieve, which is a tool used for separating particles based on size. Sieves are commonly used to classify and separate granular materials. The size of a sieve is typically defined by the dimensions of the openings in the sieve mesh (as used herein a sieve size of 0.5 mm indicates particles of 0.5 mm or smaller pass through the sieve), which are usually square or rectangular. The size of these openings is measured in terms of the mesh size, which represents the number of openings per linear inch (or per centimeter) of the sieve. For example, a sieve with a mesh size of 100 means that there are 100 openings per linear inch (or per 2.54 centimeters) of the sieve. Generally, the higher the mesh number, the smaller the openings in the sieve, and thus the finer the particles that can pass through it. Another step of the process includes contacting a selected individual fluid permeable receptacle with the selected spirit or alcoholic beverage, including dipping or submerging the fluid permeable receptacle into the spirit or alcoholic beverage, or pouring the alcoholic beverage over the fluid permeable receptacle. Allowing the fluid permeable receptacle to soak or steep in the spirit or alcoholic beverage. The fluid permeable receptacle can be in contact with the spirit or alcoholic beverage for various times at various temperatures. Time being from minutes, to hours, to days, to months. In certain aspects the fluid permeable receptacle can be soaked or steeped for 1, 2, 3, 4, 5, 6, 7, 8, 9, 10 minutes, hours, or days. Temperature can be from below room temperature, at room temperature, or above room temperature. In certain aspects the temperature can be above the freezing point or below the boiling point of the spirit or alcoholic beverage. As a non-limiting example the temperature for soaking or steeping can be from 30, 40, 50, 60, 70 to 80° F., or any value or range there between. The process can be repeated multiple times with the same or different packet or bag. In certain aspects the alcoholic beverage containing the packet or bag can be taken through a number of heating and cooling cycles.

1. A method of finishing an alcoholic beverage comprising:
(i) contacting a volume of spirit or an alcoholic beverage with particles of a finishing wood retained in a fluid permeable receptacle;
(ii) soaking the fluid permeable receptacle in the spirit or the alcoholic beverage at a temperature of 0 to 90 degrees Celsius.

2. The method of claim 1, wherein the volume of spirit or alcoholic beverage is 0.5 to 6 ounces.

3. The method of claim 1, wherein the soaking step is for 1 minute to 2 hours.

4. The method of claim 1, further comprising removing the fluid permeable receptacle after a predetermined time.

5. The method of claim 1, wherein the particles of a finishing wood have a screen size of 0.5 mm to 10 mm.

6. The method of claim 1, wherein the finishing wood is a roasted finishing wood.

7. The method of claim 1, wherein the finishing wood is oak, maple, birch, cherry, mulberry, apple wood, amburana, alder, hickory, mesquite, pecan, boxelder, or walnut.

8. The method of claim 1, wherein two or more finishing woods are retained in the same fluid permeable receptacle.

9. The method of claim 1, wherein the fluid permeable receptacle is a cotton bag, paper bag, or polymer bag.

10. The method of claim 1, wherein the fluid permeable receptacle is a wire mesh container or a perforated metal container.

11. The method of claim 1, wherein the single pour container is a whiskey glass, glencairn nosing glass, rocks glass, wine glass, brandy snifter, highball glass or a neat glass.

12. (canceled)

13. (canceled)

14. (canceled)

15. A finishing assembly comprising a finishing wood retained in a fluid permeable receptacle, the fluid permeable receptacle configured to be placed in a volume of spirit or alcoholic beverage and at least partially submerged in the spirit or the alcoholic beverage.

16. The assembly of claim 15, wherein the finishing wood is a roasted finishing wood.

17. The assembly of claim 15, wherein the finishing wood is oak, maple, birch, cherry, mulberry, apple wood, amburana, alder, hickory, mesquite, pecan, boxelder, or walnut.

18. The assembly of claim 15, wherein two or more finishing woods are retained.

19. The assembly of claim 15, wherein the fluid permeable receptacle is a cotton bag, a paper bag, or a polymer bag.

20. The assembly of claim 15, wherein the fluid permeable receptacle is a wire mesh container or a perforated metal container.

21. The assembly of claim 15, wherein the container is a whiskey glass, glencairn nosing glass, rocks glass, wine glass, brandy snifter, highball glass or a neat glass.

22. The assembly of claim 15, wherein the fluid permeable receptacle is attached to a retrieval component.

23. The assembly of claim 22, wherein the retrieval component is a string, chain, or stick.
